(19) United States
(12) Patent Application Publication
(10) Pub. No.: US 2019/0044166 A1
(43) Pub. Date: Feb. 7, 2019

(54) PRESSURE CONTROL SYSTEM, FUEL CELL ASSEMBLY AND USE OF SAID CONTROL SYSTEM

(71) Applicant: SAFRAN POWER UNITS, Toulouse (FR)

(72) Inventor: Serge Daniel LE GONIDEC, Vernon (FR)

(73) Assignee: SAFRAN POWER UNITS, Toulouse (FR)

(21) Appl. No.: 16/072,628

(22) PCT Filed: Jan. 26, 2017
(86) PCT No.: PCT/FR2017/050176

§ 371 Date: Jul. 25, 2018

(30) Foreign Application Priority Data
Jan. 26, 2016 (FR) 1650619

(51) Int. Cl. H01M 8/04746; H01M 8/0438; G05D 16/20

(52) U.S. Cl. CPC H01M 8/04761; G05D 16/2013; H01M 8/0441; H01M 8/04402

(57) ABSTRACT

A pressure regulator system (100) for regulating a pressure in a fluid line (16A) in such a manner that the pressure complies with a predetermined regulation criterion. The system comprises a valve (20A) that is controllable in on/off mode arranged at a downstream end of the line (16A) and suitable for oscillating between an open position and a closed position; a pressure sensor (40A) connected to the line (16A) and serving to measure the pressure in the line upstream from the valve (20A); and a regulator unit (50) configured to transmit to the valve (20A) open/close commands that are determined as a function of the measured pressure. A constant frequency imposes open periods (Oi) on the valve. The durations of the open periods are modulated in such a manner that the pressure in the line complies with said predetermined criterion.

### FIELD OF THE INVENTION

The invention relates to a pressure regulator system, which system is used to regulate the pressure in a fluid line in such a manner that the pressure complies with a predetermined criterion.

### TECHNOLOGICAL BACKGROUND

The invention relates particularly to regulating pressure in the exhaust lines of fuel cells, regardless of whether the line is the exhaust line of the oxygen circuit (which serves to discharge the mixture of water and oxygen produced by the cell) or the exhaust line of the hydrogen circuit (which serves to discharge the hydrogen that is not consumed by the fuel cell).

In this document, the term “line” designates a fluid pipe, the pipe possibly including equipment for use in the transport of the fluid, such as valves, etc.

In fuel cells, and in particular in proton exchange membrane fuel cells (PEMFCs), and more particularly those that operate at high temperature (HT), it is necessary to regulate the exhaust pressure from the fuel cell, preferably both in the hydrogen circuit and in the oxygen circuit, in order to ensure that the cell operates stably.

Usually, pressure is regulated by means of a regulator valve that is continuous. Such a valve can occupy a range of positions that are continuous between a closed position and an open position. The regulator valve is controlled by a regulator unit associated with a pressure sensor. As a result of information about the pressure in the line as measured by the pressure sensor, the regulator unit causes the degree of opening of the valve to be varied continuously in such a manner that the pressure in the line stabilizes on the desired value.

That solution suffers from the drawback of requiring the use of a regulator valve that is relatively expensive, and that is difficult to control because of the sometimes complex behavior relationships of such valves.

Other solutions are based on hydromechanical equipment, such as an expander, a discharge valve, or indeed a flow regulator; however the function performed by such equipment usually remains relatively primitive and is thus remote from being optimum.

### SUMMARY OF THE INVENTION

The invention thus seeks to propose a pressure regulator system for regulating a pressure in a fluid line in such a manner that the pressure complies with a predetermined criterion, which system is simpler and less expensive than prior art systems, while retaining great reliability.

This object is achieved by a pressure regulator system comprising:

a valve that is controllable in on/off mode arranged in the line or at a downstream end of the line (preferably at its downstream end) and suitable for oscillating between an open position and a closed position; a pressure sensor connected to the line and serving to measure the pressure in the line; and a regulator unit configured to prepare open/close commands and to transmit them to the valve, said commands being determined as a function of the measured pressure and imposing open periods on the valve at a constant frequency, the durations of the open periods being modulated in such a manner that the pressure in the line complies with said predetermined criterion.

In this system, it can readily be understood that the open periods are spaced apart by closed periods.

The pressure regulation seeks to ensure that the pressure in the line complies with a predetermined criterion. Usually, the criterion is defined merely by a desired pressure or a desired pressure range: the pressure is then regulated in the line in such a manner that the pressure is continuously equal to the desired pressure, or remains continuously within the desired pressure range. By way of example, the criterion may define desired values or value ranges for the pressure in the line as a function of time.

As its main fluid flow component, the system has a valve that is controllable in on/off mode: the valve is generally a solenoid valve. Advantageously, such a valve is generally simple, and thus presents high reliability and low cost.

Preferably, the controllable valve is the only valve arranged in the exhaust line and involved in regulating pressure in that line. The exhaust line then does not have any other valve for regulating pressure. In particular, it need not have any pressure limiter and/or regulator valve, whether in the form of a pressure limiter or a pressure regulator, configured respectively to use means (in particular mechanical means) to ensure that the pressure upstream or downstream from the limiter or respectively from the regulator remains below a predetermined value. (Nevertheless, the exhaust line could naturally include a pressure limiter rated at a value such that in normal operation it does not act in regulating the pressure in the exhaust line.)

The controllable valve is suitable for oscillating between an open position and a closed position, i.e. for alternating between one position and the other in repeated manner and at a relatively fast rate.

These reciprocating movements or oscillations are performed at a fixed frequency.

By using functions that are relatively simple to combine on an electronic card, the regulator unit serves to control the controllable valve. The regulation is of the pulse width modulation (PWM) type. Such control can be implemented on an electronic card. The regulation may be performed by controlling, i.e. varying, as a function of the value of the duty ratio of the valve (the ratio of its open time over total time). Advantageously, this mode of regulation makes it possible to perform substantially continuous regulation of the flow passing through the valve, even though the valve is not a continuous regulation valve.

The regulator unit may be configured to perform any known regulation algorithm or technology. For example, the regulator unit may perform proportional integral derivative (PID) type regulation. The regulation that is performed may optionally be more complex, and for example it may be of the integration, advance/retard, selective filter, lowpass filter, or other types.

In an embodiment, in order to determine the open/close commands for transmitting to the valve, the regulator unit is configured in a first step to prepare a flow rate command (for the flow rate of fluid through the valve) as a function of the measured pressure. This step may be performed by any known method for regulating pressure as a function of flow rate. In particular, the above-mentioned methods (PID, advance/retard, selective filter, and/or lowpass filter types of regulation) may be performed during this step.

In this embodiment, the regulator unit is also configured, in a second step, to determine the above-mentioned open/close commands for the valve as a function of the flow rate.

Regulation by pulse width modulation makes it possible to control the flow rate of fluid passing through the valve. It has been found that such control is sufficient and effective in regulating pressure in a line.

Nevertheless, the use of a valve that is controllable in on/off mode and that is regulated by a PWM type command can still lead to pressure fluctuations being generated in the line.

In certain embodiments, these fluctuations are negligible.

Nevertheless, in certain circumstances, these pressure fluctuations can disturb the pressure regulation that is performed. It is then appropriate to take these interfering fluctuations into account in order to improve the regulation that is performed.

For this purpose, in an embodiment, the regulator unit includes a filter module that is configured to provide a filtered pressure value in which a frequency component of frequency equal to said constant frequency is attenuated by at least 40 decibels (dB), and a regulator module that is configured to determine a command for the valve as a function of the filtered pressure value.

Advantageously, eliminating the frequency component corresponding to the oscillation frequency of the valve (the “constant” frequency) from the pressure signal serves to eliminate from the pressure signal substantially all of the interfering disturbances induced by the valve being periodically opened and closed.

The regulator unit may also include an input module configured to acquire information that is variable for the purpose of updating the regulation criterion. For example, the input module may serve to acquire a new value desired for the pressure in the line, or a new range of values that are acceptable in the line.

Another possible improvement of the pressure regulator system of the invention consists in also providing the system with a chamber interposed on the line. The chamber then forms a damping chamber serving to reduce the magnitude of the periodic pressure fluctuations induced by the valve being periodically opened and closed.

The chamber is preferably arranged in the proximity of the valve.

The chamber may have only one fluid inlet orifice and only one fluid outlet orifice, however it could optionally also include other fluid exchange orifices.

In an embodiment, the pressure sensor is configured to measure pressure in the chamber. In other words, a transducer that is sensitive to the pressure of the fluid, and that forms part of the pressure sensor, presents a pressure sensing area that is located in the chamber (or in the immediate proximity thereof).

Finally, the invention seeks secondly to propose a fuel cell assembly having a pressure regulator system enabling the pressure in an exhaust line of the fuel cell to be regulated in such a manner that the pressure complies with a predetermined criterion so that the fuel cell assembly is simpler and less expensive than prior fuel cell assemblies that provide pressure regulation in at least one exhaust line of the fuel cell, while nevertheless remaining very reliable.

This object is achieved by a fuel cell assembly comprising a fuel cell, a hydrogen or oxygen exhaust line of the fuel cell, and a regulator system as defined above and configured to regulate the pressure in said exhaust line of the fuel cell.

The invention also provides the use of a regulator system as defined above for regulating the exhaust pressure of a fuel cell, in particular the exhaust pressure in the exhaust line of the oxygen circuit of the cell and/or in the exhaust line of the hydrogen circuit of the cell. When the regulator system regulates pressure jointly in both exhaust lines, each of the various characteristics envisaged above for regulating pressure in the exhaust line may optionally be provided for both of the exhaust lines.

The invention also provides a fuel cell assembly comprising a fuel cell, an exhaust line of the fuel cell, and a regulator system configured to regulate pressure in the exhaust line of the fuel cell in such a manner that the pressure complies with a predetermined regulation criterion;

the regulation system comprising:

a pressure sensor connected to the exhaust line and serving to measure the pressure in the exhaust line; and

a valve that is controllable in on/off mode arranged in the exhaust line and suitable for oscillating between an open position and a closed position; and

a regulator unit configured to prepare open/close commands and to transmit them to the valve, said commands being determined as a function of the measured pressure, and imposing open periods on the valve at a constant frequency, the durations of the open periods being modulated in such a manner that the pressure in the line complies with said predetermined criterion.

In an embodiment, the regulator unit comprises a filter module configured to supply a filtered pressure value in which a frequency component of frequency equal to said constant frequency is attenuated by at least 40 dB, and a regulator module configured to determine a command for the valve as a function of the filtered pressure value.

In an embodiment, the fuel cell assembly further comprises a chamber interposed in the exhaust line. In particular, the pressure sensor may then be configured to measure pressure in the chamber.

In an embodiment, the regulator unit is configured in a first step to prepare a flow rate command as a function of the measured pressure, and in a second step to determine said open/close commands for the valve as a function of the flow rate.

In an embodiment, the regulator system is configured to regulate the exhaust pressure in the exhaust line of an oxygen circuit of the fuel cell or in the exhaust line of a hydrogen circuit of the fuel cell.

### BRIEF DESCRIPTION OF THE DRAWINGS

The invention can be well understood and its advantages appear better on reading the following detailed description of an embodiment shown by way of non-limiting example. The description refers to the accompanying drawings, in which:

FIG. 1 is a diagrammatic view of a fuel cell assembly in accordance with the invention; and

FIG. 2 plots curves showing variation in the main variables of the pressure regulator system of the FIG. 1 fuel cell assembly during an operation of progressively opening the valve of the pressure regulator system in stages.

### DETAILED DESCRIPTION OF THE INVENTION

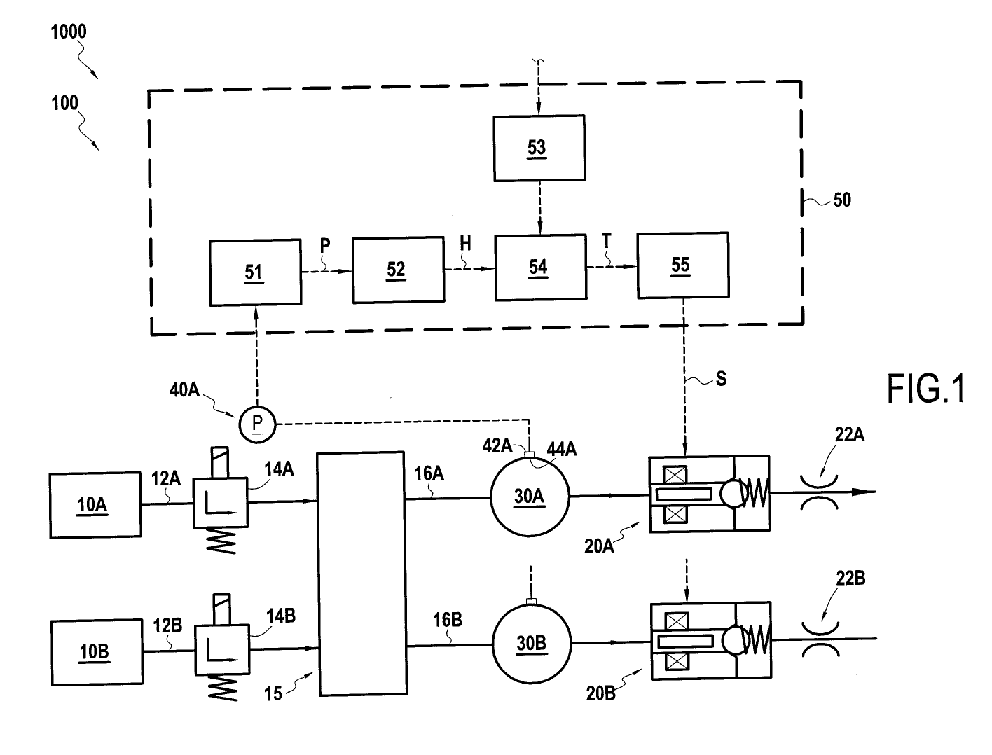

FIG. 1 is a diagram showing a fuel cell assembly 1000.

The fuel cell assembly 1000 mainly comprises a fuel cell 15.

The fuel cell 15 is fed with oxygen from an oxygen tank 10A via an oxygen line 12A, and with hydrogen from a hydrogen tank 10B via a hydrogen line 12B.

The flows in the oxygen and hydrogen lines 12A and 12B are regulated in particular by means of controllable solenoid valves 14A and 14B that are interposed in the lines 12A and 12B.

Downstream from the fuel cell 15, any surplus oxygen and water formed by the fuel cell 15 is discharged by a (water-oxygen) exhaust line 16A, while any surplus hydrogen is discharged by a hydrogen exhaust line 16B.

The oxygen line 12A, the portion of the fuel cell 15 in which oxygen flows, and the exhaust line 16A constitute the oxygen circuit, while the hydrogen line 12B, the portion of the fuel cell 15 in which hydrogen flows, and the exhaust line 16B constitute the hydrogen circuit.

The fuel cell assembly 1000 also comprises a pressure regulator system 100 in accordance with the invention and configured to regulate the pressures in the lines 16A and 16B.

Since pressure is regulated in the line 16B in a manner that is substantially identical to the manner in which pressure is regulated in the line 16A, only the regulation of pressure in the line 16A is described.

To regulate this pressure, the pressure regulator system 100 comprises a regulator unit 50, a damping chamber 30A with a pressure sensor 40A, a pressure regulator valve 20A, and a constriction 22A.

The damping chamber 30A, the controllable pressure regulator valve 20A, and the constriction 22A are interposed in that order in the exhaust line 16A downstream from the fuel cell 15. A damping chamber 30B, a controllable pressure regulator valve 20B, and a constriction 22B are interposed in the same manner in the line 16B.

One of the main functions of the regulator system 100 is to regulate the pressure in the line 16A. It is necessary to maintain a pressure in this line that is constant, or at least regular, specifically in order to enable the fuel cell 15 to operate stably. It is therefore necessary to regulate the pressure in the line 16A, i.e. in this example to stabilize this pressure on a desired value P0. Thus, in the present example, the predetermined criterion with which the system 100 seeks to comply is that the pressure in the line 16A remains substantially equal to the pressure P0.

The damping chamber 30A interposed in the line 16A upstream from the valve 20A is a chamber that has a certain inside volume. By means of this chamber, pressure fluctuations caused by substantially periodic oscillations of the valve 20A are damped.

The pressure sensor 40A is configured to measure pressure in the chamber 30A, upstream from the valve 20A. For this purpose, the sensor 40A includes a transducer 42A, e.g. of the strain gauge bridge type that is sensitive to pressure, presenting a pressure-sensing surface 44A that is to be found in the chamber 30A.

The pressure information collected at a regular frequency by the sensor 40A is transmitted to the regulator unit 50.

The regulator unit 50 has five modules:

A pressure signal conditioning module 51, a filter module 52, a setpoint acquisition module 53, a regulator module 54, and an output signal conditioning module 55. These modules may be analog modules or digital modules.

The pressure signal conditioning module 51 is an electronic module that receives as input the signal issued by the pressure sensor 40A, and that conditions or converts it into a signal P that is suitable for use by the filter module 52.

The filter module 52 is an electronic module that receives as input the pressure signal P as conditioned by the conditioning module 51. It filters this signal so as to deliver a filtered pressure value H in which the frequency component at the frequency equal to the oscillation frequency (frequency of the

PWM control cycle) of the valve 20 is attenuated. This attenuation must be by at least 40 dB, but it may have any other value depending on the situation of the system under consideration, depending in particular on the response time of the valve, on the volume of the capacity, on the natural filter of the sensor, . . . ).

In the example shown, the filter module 52 performs a transfer function that may be of the following form, for example:

$${H}_{( filter )} = \frac{1 + \frac{{p}^{2}}{{ω}^{2}}}{1 + 2 \times ζ \times \frac{p}{ω} + \frac{{p}^{2}}{{ω}^{2}}}$$

In this expression:

ζ is a constant damping parameter; in this example its value is 0.707; and

ω represents the angular frequency of the selected filter expressed in radians per second. The transfer function H provided by the filter module 52 is selected so as to reduce pressure components fluctuating at the angular frequency ω.

In the embodiment described, since the valve has a first resonant frequency at a frequency of 30 hertz (Hz), this angular frequency ω is given by: ω=30*2π*f i.e. about 188.5 rad/s.

The filtered pressure signal H produced by filter module 52 is transmitted to the regulator module 54.

The acquisition module or setpoint acquisition module 53 serves to transmit new values, i.e. new setpoints for the regulation criterion to the regulator unit 50. For example, it serves to vary the pressure P0 on which the pressure P in the line 16A is regulated. The values required by the acquisition module 53 are transmitted to the regulator module 54.

The regulator module 54 acts on the basis of the filtered pressure signal H to determine commands for the valve 20A in such a manner as to comply with the intended regulation criterion (possibly updated by information transmitted by the acquisition module 53).

In a first step, the regulator unit determines the flow rate desired through the valve on the basis of the filtered pressure signal H received from the filter module 52, in such a manner that the pressure upstream from the valve complies with the predetermined criterion, specifically in this example, remains equal to the pressure P0.

Thereafter, in a second step, the regulator unit determines the duty ratio R of the valve 20A on the basis of the desired flow rate as determined during the first step.

The first two steps may optionally be performed in a single operation: under such circumstances, the module 54 defines the desired value for the duty ratio R as a function of the filtered pressure signal H received from the filter module 52 so that the pressure upstream from the valve complies with the predetermined criterion.

Once this desired value for the duty ratio R has been defined, the module 54 acts in a third step to convert this value R into a command or a sequence of commands T defining the open/closed periods of the valve 20A. The duration of the open periods is modulated so that the duty ratio R of the valve 20A is equal to the value determined by the second processing step.

In known manner, this third step may be performed by a method of pulse width modulation that is said to be “intersective”. In this method, the input signal (in this example the signal that presents the desired value for the duty ratio R) is compared with a triangular (sawtooth) signal. The output signal, which defines the degree of opening of the valve 20A, is then equal to 1 if the input signal is greater than the triangular signal, and otherwise it is equal to 0. The output signal thus changes state each time there is an intersection between the input signal and the triangular signal.

The output signal conditioning module 55 then receives the output signal T as produced by the regulator module 54 and it performs conversion (voltage, power, etc. conversion) so as to obtain a signal S that is appropriate for the command channel of the valve 20A.

This signal S is then transmitted to the valve 20A, which adopts the position specified by the signal it received.

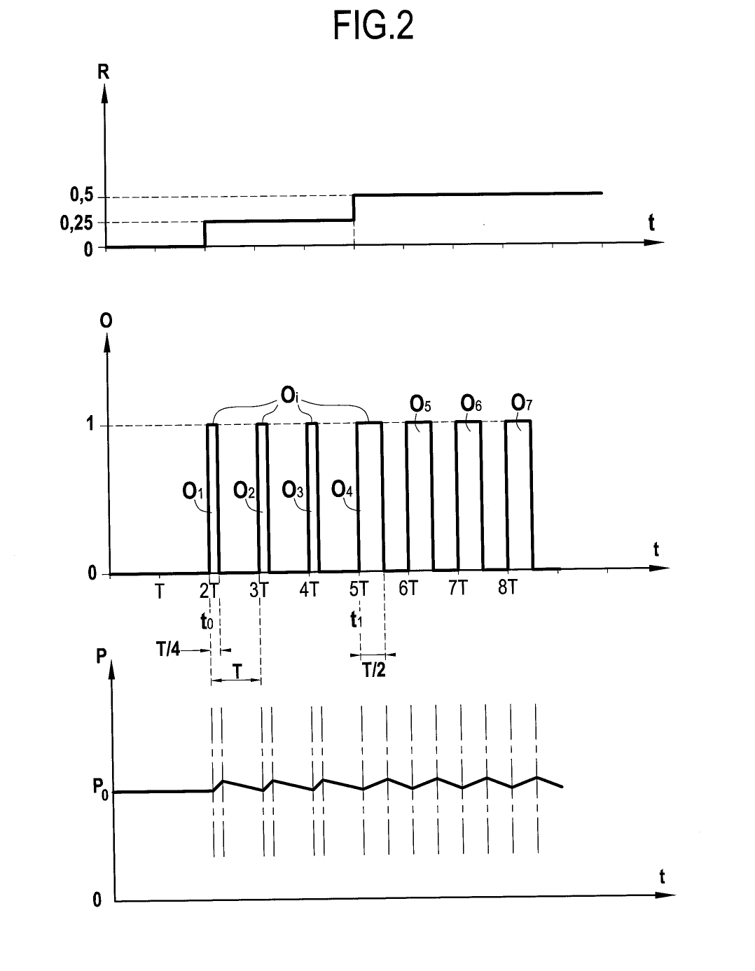

For a given period of time, FIG. 2 shows an example of open/close commands prepared by the regulator unit 50 and transmitted to the valve 20A.

The top curve shows variations in the duty ratio R of the valve 20A as a function of time.

The middle curve shows variations in the degree of opening of the valve 20A as a function of time.

The bottom curve shows variations in the pressure P in the line 16A as a function of time.

The valve 20A is a valve that is designed to oscillate between an open position and a closed position. Its degree of opening O thus varies between a value 0 when the valve is closed and a value 1 when the valve is opened.

The valve 20A receives open/close commands that impose open periods Oi thereon at constant intervals (or at a constant frequency). Between two open periods Oi, the valve is closed (O=0).

In the example shown, the duration of the constant intervals is set at a value T of 33.3 milliseconds (ms). The corresponding frequency, 1/T, is equal to 30 Hz.

In the example described, the frequency of the open periods is considered as the open command frequency. These commands are issued at a constant frequency, at the instants T, 2T, 3T, 4T, etc. Nevertheless, it can be understood that while still remaining within the ambit of the invention, the frequency of the open periods Oi could also be based on some other parameter depending on the open/close commands for the valve 20A. For example, the frequency of the open periods may be determined from the end-of-open-period instants (i.e. the close command instants). It could also be determined on the basis of median instants for the open periods Oi.

The durations of the open periods Oᵢ are modulated by the regulator unit 50 so that the pressure in the line remains continuously equal or substantially equal to the desired value.

For this purpose, during the time period shown in FIG. 2, the regulator unit acts during the first and second above-described processing steps to determine that the duty ratio R is to vary as follows: from the initial instant to an instant t0, the valve 20 is to remain closed; from the instant t0 to an instant t1, the duty ratio of the valve is to be equal to 0.25; and from the instant t1, the duty ratio of the valve is to be 0.5.

This command relating to the duty ratio R is transcribed in the form of open period commands Oi by modifying the durations of the open periods Oi: during the preceding period t0, the valve is to remain closed; the duration of the open periods then being zero.

From the instant t0 to the instant t1, there are three open periods O1 to O3. For the duty ratio to be equal to 0.25, the duration of the open periods is T/4.

As from the instant t1, the duty ratio is to be equal to 0.5. The duration of the open periods then becomes T/2.

Although the present invention is described with reference to specific embodiments, it is clear that various modifications and changes may be undertaken on those embodiments without going beyond the general ambit of the invention as defined by the claims. The oxidizer used by the fuel cell may for example be air instead of oxygen. Consequently, the description and the drawings should be considered in a sense that is illustrative rather than restrictive.

1. A fuel cell assembly comprising a fuel cell, an exhaust line of the fuel cell, and a regulator system configured for regulating a pressure in the exhaust line of the fuel cell in such a manner that the pressure complies with a predetermined regulation criterion, the regulator system comprising:
a valve that is controllable in on/off mode arranged at a downstream end of the line and suitable for oscillating between an open position and a closed position;
a pressure sensor connected to the exhaust line and serving to measure the pressure in the exhaust line; and
a regulator unit configured to prepare open/close commands and to transmit them to the valve, said commands being determined as a function of the measured pressure and imposing open periods on the valve at a constant frequency, the durations of the open periods being modulated in such a manner that the pressure in the line complies with said predetermined criterion.

2. A fuel cell assembly according to claim 1, in which the regulator unit comprises:
a filter module configured to supply a filtered pressure value in which a frequency component of frequency equal to said constant frequency is attenuated by at least 40 dB; and
a regulator module configured to determine a command for the valve as a function of the filtered pressure value.

3. A fuel cell assembly according to claim 1, further comprising a chamber interposed in the exhaust line.

4. A fuel cell assembly according to claim 3, wherein the pressure sensor is configured to measure pressure in the chamber.

5. A fuel cell assembly according to claims 1, wherein the regulator unit is configured in a first step to prepare a flow rate command as a function of the measured pressure, and in a second step to determine said open/close commands for the valve as a function of the flow rate.

6. (canceled)

7. A fuel cell assembly according to claims 1, whose regulator system is configured to regulate the exhaust pressure in the exhaust line of an oxygen circuit of a fuel cell or in the exhaust line of a hydrogen circuit of a fuel cell.

8. A fuel cell assembly according to claim 2, further comprising a chamber interposed in the exhaust line.

9. A fuel cell assembly according to claim 7, wherein the pressure sensor is configured to measure pressure in the chamber.
